(19) United States
(12) Patent Application Publication
(10) Pub. No.: US 2024/0340610 A1
(43) Pub. Date: Oct. 10, 2024

(54) NETWORK NODE, USER EQUIPMENT AND METHODS IN A WIRELESS COMMUNICATIONS NETWORK

(71) Applicant: Telefonaktiebolaget LM Ericsson (publ), Stockholm (SE)

(72) Inventors: Tore LINDGREN, Luleå (SE); Sara SANDBERG, Luleå (SE)

(21) Appl. No.: 18/290,869

(22) PCT Filed: Jul. 27, 2021
(86) PCT No.: PCT/SE2021/050754

§ 371 Date: Jan. 22, 2024

(51) Int. Cl. H04W 4/02; H04W 64/00

(52) U.S. Cl. CPC H04W 4/02; H04W 64/006

(57) ABSTRACT

A method performed by a network node, a User Equipment (UE), or both, for determining reliability of positions of the UE in a wireless communications network is provided. The method performed by the network node includes obtaining a first position of the UE, obtaining a second position of the UE, and determining whether or not the first position and the second position of the UE are reliable based on comparing of the first position and the second position. The comparison includes determining that the first position and the second position of the UE are reliable when the difference between the first position and the second position is below a first threshold, and determining that the first position and the second position of the UE are not reliable when the difference between the first position and the second position is above a second threshold.

### TECHNICAL FIELD

Embodiments herein relate to a network node, a User Equipment (UE), and methods therein. Furthermore, a computer program product and a computer-readable storage medium are also provided herein. In some aspects, embodiments relate to determining reliability of estimated positions of the UE in a wireless communications network.

### BACKGROUND

In a typical wireless communications network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part, and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area or indoor area where radio coverage is provided by the radio network node. The radio network node communicates over an air interface operating on radio frequencies with the wireless device within range of the radio network node.

The 3rd Generation Partnership Project (3GPP) is the standardization body that specifies the standards for the cellular system evolution, e.g., 3G, 4G, 5G and the future evolutions. Specifications for the Evolved Packet System (EPS), also called a Fourth Generation (4G) network, have been completed within the 3GPP. As a continued network evolution, the new releases of 3GPP specify a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but they have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as a UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques are used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

The 5G technology allows creating manufacturing factories, warehouses, harbours, transportation facilities, airport facilities, construction sites and other smart facilities that can encompass partially or fully autonomous robots, drones, transportation devices, and various other equipment. Such characteristics of a 5G network as low latency, high reliability, high bandwidth, and connection density may be utilized to deploy automated 5G-enabled equipment in various settings.

A safe and efficient operation of an industrial factory or another facility, or a drone system, indoor and/or outdoor, including automated equipment, requires correct estimation of positions of devices within that setting. Accurate and timely position determination is particularly important in indoor and outdoor environments where autonomous robotic equipment operates in the same space as humans. Also, a high positioning reliability is essential for autonomous and semi-autonomous vehicles. Furthermore, drones need to be positioned correctly, especially in situations when they fly beyond a remote operator's visual line of sight, over people, at night, or perform other complex actions. In various settings, an incorrect determination of a position of a moving device may cause serious consequences, including those that endanger human safety. An unreliable detection of a position of a wireless device, e.g. a 5G-enabled device, may also result in loss of resources and increased costs of operating a smart facility or a drone system.

### SUMMARY

An object of embodiments herein is to improve the way of handling estimated positions of UEs in a wireless communications network.

According to an aspect of embodiments herein, the object is achieved by a method performed by a network node for determining reliability of positions of a User Equipment, UE, in a wireless communications network. The network node obtains a first position of the UE, and the network node also obtains a second position of the UE. The network node determines whether or not the first position and the second position of the UE are reliable based on comparing of the first position of the UE and the second position of the UE. The comparison comprises determining that the first position and the second position of the UE are reliable when the difference between the first position of the UE and the second position of the UE is below a first threshold, and determining that the first position and the second position of the UE are not reliable when the difference between the first position of the UE and the second position of the UE is above a second threshold.

According to another aspect of embodiments herein, the object is achieved by a method performed by a UE for determining reliability of positions of the UE in a wireless communications network. The UE obtains a first position of the UE, and the UE also obtains a second position of the UE. The UE further determines whether or not the first position and the second position of the UE are reliable based on comparing of the first position of the UE and the second position of the UE. The comparison comprises determining that the first position and the second position of the UE are reliable when the difference between the first position of the UE and the second position of the UE is below a first threshold, and determining that the first position and the second position of the UE are not reliable when the difference between the first position of the UE and the second position of the UE is above a second threshold.

According to an aspect of embodiments herein, the object is achieved by a network node configured to determine reliability of positions of a UE in a wireless communications network. The network node is further configured to:
Obtain a first position of the UE;
obtain a second position of the UE; and
determine whether or not the first position and the second position of the UE are reliable based on comparing of the first position of the UE, and the second position of the UE, by
   determining that the first position and the second position of the UE are reliable when the difference between the first position of the UE and the second position of the UE is below a first threshold, and
   determining that the first position and the second position of the UE are not reliable when the difference between the first position of the UE and the second position of the UE is above a second threshold.

According to another aspect of embodiments herein, the object is achieved by a UE configured to determine reliability of positions of the UE in a wireless communications network. The UE is further configured to:
Obtain a first position of the UE;
obtain a second position of the UE; and
determine whether or not the first position and the second position of the UE are reliable based on comparing of the first position of the UE, and the second position of the UE, by
   determining that the first position and the second position of the UE are reliable when the difference between the first position of the UE and the second position of the UE is below a first threshold, and
   determining that the first position and the second position of the UE are not reliable when the difference between the first position of the UE and the second position of the UE is above a second threshold.

Since two obtained positions of the UE are compared to see if they are different or not, the network node or UE may, based on this, determine whether or not the first position and the second position of the UE are reliable. If they are close to each other or the same they are reliable. But if they are different, at least one of the positions is false, and therefore the positions are not reliable. To be aware of this, the way of handling the estimated positions of the UE is improved. This in turn results in an improved way to control operation of the UE in the wireless communications network, whereby overall performance and safety of the wireless communications network may be improved.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting an embodiment of a method in a network node.

FIG. 3 is a flowchart depicting an embodiment of a method in a user equipment.

FIG. 4 is a schematic block diagram illustrating an embodiment of positioning in a NR network.

FIGS. 5a-5b are schematic block diagrams illustrating a network node according to embodiments herein.

FIGS. 6a-6b are schematic block diagrams illustrating a user equipment according to embodiments herein.

FIG. 7 schematically illustrates a telecommunication network connected via an intermediate network to a host computer.

FIG. 8 is a generalized block diagram of a host computer communicating via a base station with a user equipment over a partially wireless connection.

FIGS. 9, 10, 11, and 12 are flowcharts illustrating methods implemented in a communication system including a host computer, a base station and a user equipment.

### DETAILED DESCRIPTION

Example embodiments herein relate to methods, UEs, and network nodes for determining whether or not positions of a UE in a wireless communications network is estimated reliably, and in some embodiments generating a warning when the positions are not reliable.

Although accurate and reliable position determination of a UE in a wireless communications network is indispensable for operation of the UE and associated devices in various settings, reliable determination of a UE's position may be compromised. For example, a UE which is or is associated with an autonomous or a semi-autonomous robot, vehicle, or drone often operates in an environment in which a position of the UE may be determined with a less than required reliability, e.g., with a reduced integrity, due to various factors.

Embodiments herein provide a method for determining if a position determined for a UE is reliable, by using different estimations of the position such as e.g. redundant network-based positioning. In some embodiments, the method described herein is based on the position of the UE being estimated redundantly, using both a UE-based positioning method and a network-based positioning method. If these estimates do not agree to a sufficient extent, a warning is sent.

In some examples of embodiments herein, a position estimate for a UE in a wireless communications network is determined redundantly, by using a first position estimated using the wireless communications network, such as, e.g., a first position estimated using at least in part a network node in the wireless communications network, and a second position estimated, e.g., using at least in part the UE. The first and second positions may be estimated using different, including not overlapping, components of the wireless communications network or components associated with the wireless communications network and/or the UE, for position estimates. As used in this disclosure, in some embodiments, the term component refers to or comprises a physical device, e.g. hardware, or software, including a firmware, or a combination thereof having one or more specific functionalities. As an example, a component may be, but is not limited to being, a network node, a base station, a UE, a processor, a sensor, an antenna, a router, a process running on the processor, computer-executable instructions, a program, and/or a computer. As an example, in some embodiments, the first and second positions may be estimated using the same radio propagation environment, but different positioning methods. As another example, in some embodiments, the second position may be estimated by the UE using one or more sensors, such that the second position does not depend on the radio propagation environment in a wireless communications network in which the UE operates. As a further example, in some embodiments, the first and second positions may be estimated using different radio channels.

In some embodiments, the same node in the wireless communications network such as, e.g., a network node or a UE, may estimate both the first and second positions of the UE. Such redundant approach allows determining reliability of positions estimated for the UE, thereby improving accuracy of detection of the position of the UE in the wireless communications network which may comprise a facility encompassing one or more out of autonomous or semi-autonomous robots, drones, or vehicles. This improves the way of handling the estimated positions of the UE. This in turn results in an improved way to control operation of the UE in the wireless communications network, whereby overall performance and safety of the wireless communications network may be improved.

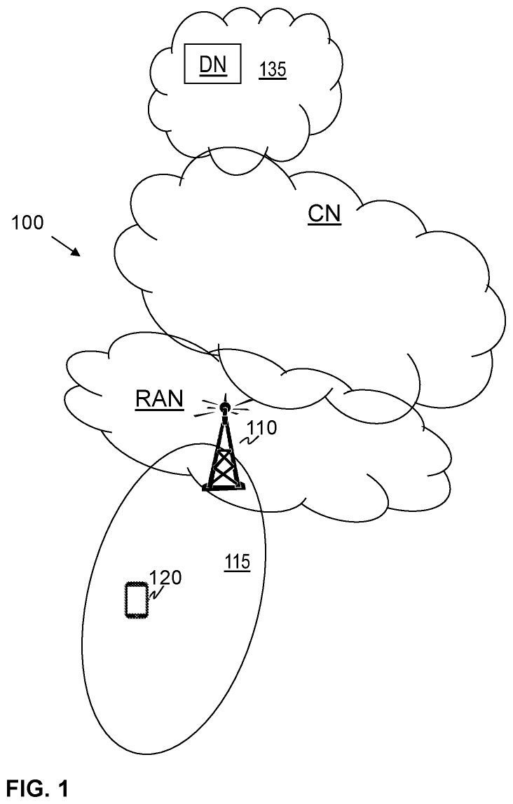

FIG. 1 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g. a network node 110. The network node 110 provides radio coverage in a cell which may also be referred to as a beam or a beam group of beams, such as a cell 115 provided by the network node 110.

The network node 110, may be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a UE 120 within the service area served by the network node 110 depending e.g. on the first radio access technology and terminology used. The radio network node 110 may communicate with the UE 120 in Downlink (DL) transmissions to the UE 120 and Uplink (UL) transmissions from the UE 120.

A number of UEs operate in the wireless communications network 100, such as, e.g., a UE 120. The UE 120 may also be referred to as a device, an IoT device, a mobile station, a non-access point (non-AP) STA, a STA, a user equipment and/or a wireless terminal, communicate via one or more Access Networks (AN), e.g. RAN, to one or more core networks (CN). It should be understood by the skilled in the art that a “wireless device” is a non-limiting term and it means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

In various embodiments, the wireless communications network 100, which may be a private network, comprises a system or facility comprising one or more autonomous or semi-autonomous robotic devices or robots. The system may be, for example, a manufacturing factory, a warehouse, a harbour, a transportation facility, an airport facility, an oil platform, a power plant, a mine, a surveillance system which may employ drones, or any other suitable system or facility, or a combination thereof. In such embodiments, the UE 120 may be a fully or partially automated robot, a robot that operates in collaboration with a human, a drone, a transportation device, a smart tool, or any other suitable device that forms part of or is associated with the wireless communications network 100 and may communicate with other devices in the wireless communications network 100.

Methods herein may e.g. be performed by the network node 110 and the UE 120. As an alternative, a Distributed Node (DN) and functionality, e.g. comprised in a cloud 135 as shown in FIG. 1, may be used for performing or partly performing the methods herein.

A number of embodiments will now be described, some of which may be seen as alternatives, while some may be used in combination.

The method for determining reliability of positions of the UE 120 may be performed in the network node 110, in the UE 120, in both the network node 110 and the UE 120 in parallel or in any other node in the wireless communications network 100, or in any combination of one or more thereof. The network node 110 and the UE 120 may perform determining reliability of positions simultaneously or at different times. Regardless of the specific timing of various components at the wireless communications network 100, at a given time point, a reliability of positions of the UE 120 may be determined at one or more components, some of which may determine the reliability at the same time as the other components.

In some embodiments, the wireless communications network 100 comprises more than one UE and more than one network node, and some or all of the UEs and network nodes may perform the methods in accordance with the present disclosure.

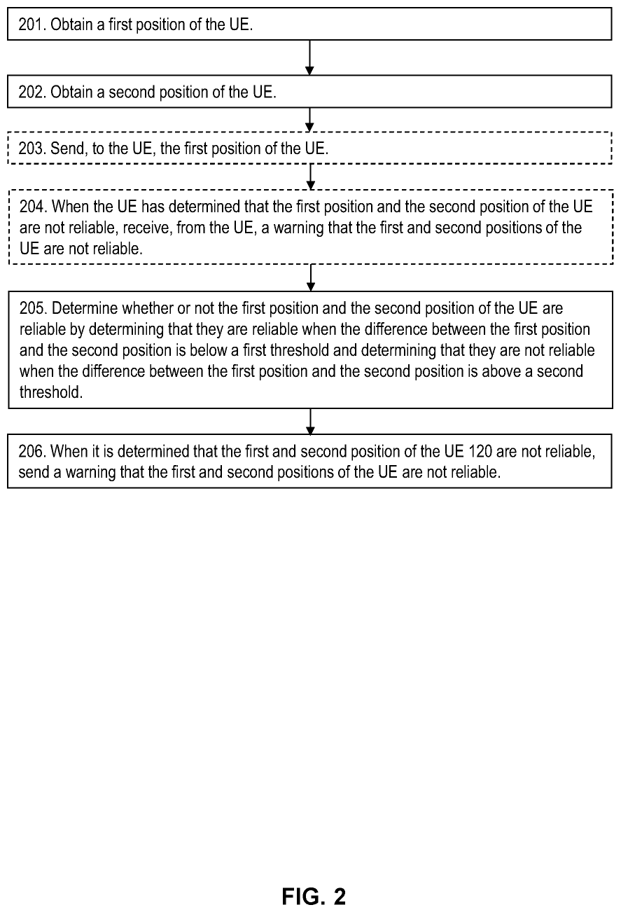

FIG. 2 shows example embodiments of a method performed by the network node 110 for determining reliability of positions of the UE 120 in the wireless communications network 100.

In some embodiments, to be able to determine reliability of UE positions, the network node 110 will collect, such as obtain, at least two different positioning estimations for the same UE 120, which are to be compared. If they have similar values, e.g. below a threshold, they are determined to be reliable, but if the position values are very different, e.g. above a threshold, they are determined to be not reliable.

The method comprises the following actions, which actions may be taken in any suitable order. Optional actions are referred to as dashed boxes in FIG. 2.

### Action 201

The network node 110 obtains a first position of the UE 120.

In some embodiments the first position of the UE 120 is obtained by e.g. being estimated by the network node 110, or by receiving it from another network node such as e.g. a base station such as e.g. a gNodeB, a location node such as e.g. a Location Management Function (LMF) node, in the cloud, etc. The first position of the UE 120 may e.g. be estimated at least in part by the network node 110. To be estimated at least in part means that one or more components of the network node 110, e.g. a processor, are involved in estimating the first position, and that one or more of other components may be involved as well.

Furthermore, in some embodiments, more than one network node may estimate the first position of the UE 120, such as, e.g., the network node 110 and one or more other network nodes in the wireless communications network 100. For example a technique such as, e.g., angle-of-arrival estimation may be used by a few network nodes surrounding the UE 120, which may or may not include the network node 110, to estimate the position of the UE 120. Other alternatives include a combination of angle-of-arrival and round-trip-time measurements with which it is possible for a single network node, such as the network node 110 to estimate the position of the UE. Additionally or alternatively, time-difference-of-arrival between a few surrounding network nodes, which may or may not include the network node 110, and the UE 120 may be used to estimate the first position of the UE 120. Regardless of which and how many network nodes take part in determining the first position of the UE 120, the network node 110 obtains a first position of the UE 120.

In some embodiments, the obtaining of the first position of the UE 120 further comprises obtaining an indication of a first integrity level of the first position. An integrity level of a position estimate may comprise one or more numerical or qualitative values, or a combination thereof, which indicate a quality or accuracy of the estimated first position of the UE 120. The integrity level of a position may generally indicate how accurate and trustworthy that position is, taken into consideration a status of one or more components, such as sensors, network nodes, etc. that determine the position.

An integrity level of a position estimate may also depend on properties of an environment in which UE positioning is performed. For example, presence of clutter and/or objects, including other UEs, reflecting radio signals in the environment may impact the positioning accuracy negatively.

In some embodiments, the first integrity level of the first position may depend on a status of the wireless communications network 100. The network status may include, e.g. the average or maximum distance between network nodes, e.g. transmission and reception points (TRPs), as a dense network may in some cases provide a higher integrity level of positioning measurements and thus a more accurate positioning than a sparser network. In addition, the integrity level may depend on an age of measurements used to estimate the position. For example, if in some embodiments, a time span during which angle-of-arrival or time-difference-of arrival measurements are made is significant (e.g., above a certain value, such as e.g. in the order of 10-100 milliseconds (ms)) in relation to the speed of a UE such as e.g. the UE 120, the integrity level may be lower as compared to a scenario when the measurements are all made within a short time span relative to a time when they are used, e.g. within a few ms or less than one ms.

Furthermore, in some embodiments, the first integrity level of the first position, or an integrity level of any other position estimated for use in accordance with embodiments of the present disclosure may depend on properties of one or more components performing estimation of the position of the UE 120. For example, a number of antenna elements is a factor that impacts the quality of an estimated position if angle-of-arrival measurements are used. As another example, another factor that may impact the quality of a position estimate is whether an indirect path, e.g., a multi-path or reflected path, has been measured rather than a direct path. The paths may be measured in different ways and used to indicate the quality of an estimated position. As another example, it may be known, for a certain point in time, that positions determined using at least in part the network node 110 are acquired with certain accuracy or integrity levels. For example, tests on achievable positioning accuracy with a specified confidence level (e.g., as one example, that 40 cm accuracy is achieved with a confidence level of 95%, or any other accuracy is achieved with a confidence level of at least 95%) may be performed once a positioning server or other component that can perform positioning using at least in part the network node 110 is installed in a facility in which the UE 120 is deployed.

In some embodiments, a sensor or other device may be associated with known integrity levels associated with acquired measurements.

In some embodiments, if the network node 110 determines that the first integrity level of the first position of the UE 120 is below a certain threshold, this first position may not be used by the network node 110, and another instance of the first position of the UE 120 may be obtained. The threshold that may be used to determine whether or not the first position is acceptable for further processing may depend on properties of an environment in which the network node 110 and the UE 120 operate, frequency with which measurements used in the calculation of the first position are acquired, a type and properties of the UE 120 and/or a device or vehicle associated with the UE 120, and other features. For example, if the UE 120 is a slowly moving device, the threshold used to determine whether or not the first position is acceptable may be low. As another example, if the environment has many obstacles, bursty traffic, etc., the threshold used to determine whether or not the first position is acceptable may be set to a higher value. Specific values of the threshold may depend on a required level of reliability of UE positioning at the network.

### Action 202

The network node 110 further obtains a second position of the UE 120.

In some embodiments, the second position of the UE 120 may be estimated at least in part by the UE 120. In some embodiments, the second position of the UE 120 is obtained by the network node 110 by receiving, e.g. from the UE 120, the position as estimated by the UE 120, or by receiving it from another network node such as e.g. the location management function (LMF) node, the cloud, or a positioning server determining the position of the UE 120 through, e.g. fusion of information from network nodes which may utilize different techniques such as, e.g., Wi-Fi, Bluetooth, 4G, 5G, or further implementations.

In some embodiments, any one out of: the first position of the UE 120 is estimated using at least in part the network node 110 and the second position of the UE 120 is estimated using at least in part the UE 120.

Similar to the first integrity level of the first position, the second integrity level of the second position may depend on properties of an environment in which UE positioning is performed, on a status of the wireless communications network 100, properties of one or more components performing estimation of the position of the UE 120, and other factors including those discussed above for the first integrity level of the first position.

In some embodiments, the obtaining of the second position of the UE 120 further comprises obtaining an indication of a second integrity level of the second position. The second integrity level of the position estimate may comprise one or more numerical or qualitative values, or a combination thereof, which indicate a quality of the estimated second position of the UE 120. For example, a sensor integrity may be monitored such that positioning measurements acquired by that sensor may be associated with corresponding integrity levels. For example, a value acquired by an Inertial Motion Unit (IMU) sensor may have an integrity level associated with the value, indicating whether that sensor operates properly, or whether an error in the sensor is detected, or whether an excessive bias detected in the IMU sensor is detected.

In some embodiments, if the network node 110 determines that the second integrity level of the second position of the UE 120 is below a certain threshold, this second position may not be used by the network node 110, and another instance of the second position of the UE 120 may be obtained. The threshold that may be used to determine whether or not the second position is acceptable for further processing, based on the associated second integrity level, may depend on factors similar to those discussed above in connection with the first integrity level of the first position.

### Action 203

In some embodiments herein, the network node 110 and the UE 120 communicate to exchange information which may include positions of the UE 120 estimated by the network node 110, the UE 120, another network node, or by any combination thereof.

Accordingly, in some embodiments, the network node 110 sends the first position of the UE 120 to the UE 120.

This may e.g. be in embodiments where the UE 120 is performing the method in parallel with the network node 110 and therefore needs the first position of the UE 120. As an alternative, the UE 120 may be performing the method at other time relative to the network node 110 performing the method. For example, the UE 120 may be performing the method at a time that at least partially overlaps with a time when the network node 110 is performing the method.

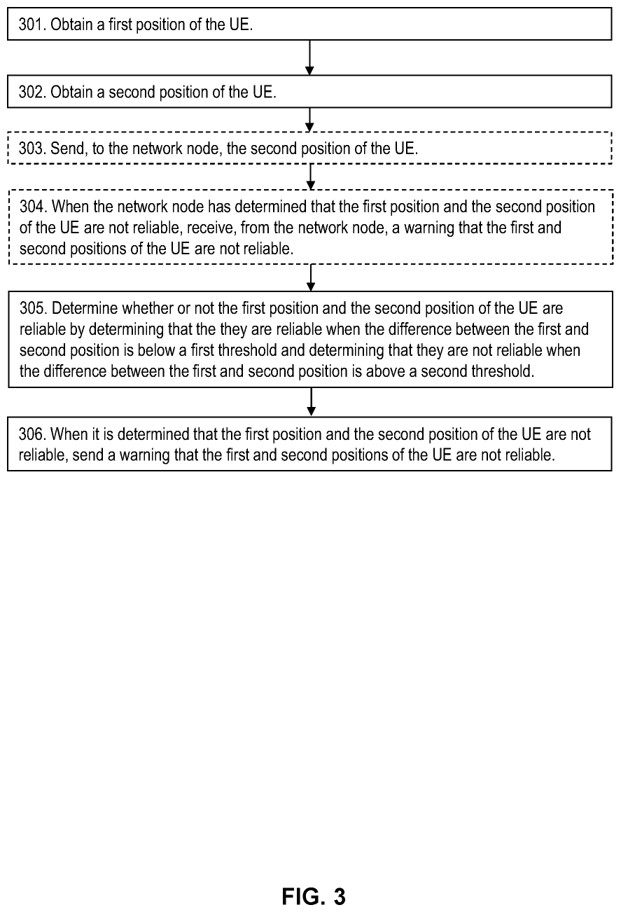

In some embodiments, the UE 120 receives from the network node 110 the first position determined by the network node 110, and the UE 120 may use the first position in determining reliability of positions estimated for the UE 120, as discussed in more detail in connection with FIG. 3, below.

### Action 204

In some embodiments, when the UE 120 has determined that the first position and the second position of the UE 120 are not reliable when the difference between the first position of the UE 120 and the second position of the UE 120 is above the second threshold, the network node 110 may further receive, from the UE 120, a warning that the first and second positions of the UE 120 are not reliable.

It should be noted that the first and second positions used by the UE 120 to generate the warning may be different instances of positions of the UE 120 from the first and second positions obtained and compared to one another by the network node 110 as described in the method of FIG. 2. Thus, the positions of the UE 120 are referred to herein as first and second positions to indicate that these positions are obtained using the wireless communications network—e.g., the first position estimated using at least in part the network node in the wireless communications network, and using the UE 120—e.g., the second position estimated using at least in part the UE 120. It should be appreciated that the UE 120 may be involved in the first position estimation, and the network node 110 may be involved in the second position estimation. It should also be noted that, in some embodiments, the second threshold used by the UE 120 may be different from the second threshold used by the network node 110 as described in the method of FIG. 2. In some embodiments, the second threshold used by the UE 120 is equal to the second threshold used by the network node 110.

The warning may be obtained as the network node 110 communicates with the UE 120 regarding positions estimated for the UE 120. The warning may have any suitable form, e.g. it may be a control signal, instruction, or any other indication that is received by the network node 110 from the UE 120. It should be appreciated that, in some embodiments, the warning may be received not directly from the UE 120 but via another node or component in the wireless communications network 100 which node or component may have received that warning from the UE. For example, in an embodiment, the warning is received from a location server in the wireless communications network 100. In some embodiments, the location server is, comprises, or is associated with a location management function (LMF) node.

In some embodiments, the warning may be received by the network node 110 from the UE 120 along with the first and second positions of the UE 120 estimated at least in part using the UE 120.

Furthermore, in some embodiments, the network node 110 receives the warning from the UE 120 and may also receive thresholds, e.g. first and second thresholds, used by the UE 120 to determine reliability of the first and second positions (action 305, below). In some cases, the network node 110 may use the same first and second thresholds that the UE 120 has used, though different thresholds may be used by the network node 110 and the UE 120 in various scenarios. In some embodiments, the network node 110 may determine whether or not to use the warning received from the UE 120, based on how similar the first and second thresholds used by the UE 120 are to their counterparts, also referred to as first and second thresholds but which may have different values, used by the network node 110. The network node 110 may use the first and second thresholds used by the UE 120 and the warning received from the UE 120 in other ways.

### Action 205

The network node 110 then determines whether or not the first position and the second position of the UE 120 are reliable based, e.g. at least in part, on comparing of the first position of the UE 120 and the second position of the UE 120. The term at least in part, when used herein, e.g. means that the reliability of the first and second positions may be determined based on other values, additionally to the first and second positions.

The determining comprises determining that the first position and the second position of the UE 120 are reliable when the difference between the first position of the UE 120 and the second position of the UE 120 is below a first threshold.

The determining further comprises determining that the first position and the second position of the UE 120 are not reliable when the difference between the first position of the UE 120 and the second position of the UE 120 is above a second threshold.

The difference between the first and second positions may be determined in any suitable way. For example, in some embodiments, the distance is a geometric distance between the two position estimates. The distance may be a geometric distance measured in a plane (e.g. in the x-y plane or floor level). In some embodiments, if a relative position is estimated, the distance may be a geometric distance between the two relative position estimates under the assumption that the position was the same at some earlier point in time that is used as reference point. In some embodiments, the geometric distance is a three-dimensional geometric distance.

In some embodiments, the second threshold is greater than the first threshold.

In some embodiments, the first and second thresholds are equal to one another. Thus, in such embodiments, the determining comprises determining that the first position and the second position of the UE 120 are reliable when the difference between the first position of the UE 120 and the second position of the UE 120 is below a certain threshold, and determining that the first position and the second position of the UE 120 are not reliable when the difference between the first position of the UE 120 and the second position of the UE 120 is above that same threshold.

In some embodiments, one or both of the first threshold and the second threshold are adjustable based on any one or more out of at least one characteristic of a system comprising the wireless communications network 100, at least one of the first integrity level of the first position and the second integrity level of the second position, and a required position reliability of the UE 120. This is an advantage since the reliability of the position thus can be adjusted to a specific use case or situation. For example, when an Automated Guided Vehicle (AGV) is moving in an area where high precision is required, e.g. when parking or when driving in close proximity to a human or another AGV, the thresholds may be lower than when the AGV is moving in a large open area. In some embodiments, the at least one characteristic relates to a required precision of detection of a position of the UE 120 in the wireless communications network 100.

In some embodiments, one or both of the first integrity level of the first position and the second integrity level of the second position are used in setting the first threshold and the second threshold. In some embodiments, for example, if the first and second positions are estimated with a high integrity level, the first and second thresholds may be set lower, meaning that a difference between the first and second positions is expected to be small. Thus, first and second positions associated with respective high first and second integrity levels may be expected to be close to one another, to be indicative of a reliable position estimation for the UE 120. Similarly, first and second positions associated with respective lower first and second integrity levels may be expected to be more different from one another to be indicative of a reliable position estimation for the UE 120, and the first and second thresholds may thus need to be set to higher value(s).

In some embodiments, the first threshold and the second threshold may be set and/or adjusted based on prior values of the first and second positions obtained by the network node. For example, if prior values of the obtained first and second positions are associated with high integrity levels, the first and second thresholds may be decreased. If however the prior values of one or both of the obtained first and second positions are associated with lower integrity levels, the first and second thresholds may be increased. In some embodiments, an average value, a median value, or another value may be computed based on two or more prior values, i.e. previously acquired first and second positions, associated with certain first and second integrity levels, respectively. The value computed based on the prior values may be adjustable, and it may be used to determine and update one or both the first and second thresholds.

In some embodiments, the first threshold and the second threshold may be set and/or adjusted based on threshold used for integrity levels for position estimates.

In some embodiments, one or both of the first threshold and the second threshold are adjustable based on all of the at least one characteristic of a system comprising the wireless communications network 100, at least one of the first integrity level of the first position and the second integrity level of the second position, and the required position reliability of the UE 120.

In some embodiments, the first and second thresholds are adjustable, e.g. dynamically adjustable. Additionally or alternatively, in some embodiments, the first and second thresholds may be manually adjustable, e.g. by an operator of the wireless communications network 100.

Furthermore, in some embodiments, the determining whether or not the first position and the second position of the UE 120 are reliable is further based on the warning received from the UE 120. In this way, the network node 110 takes into consideration results of performance of the method in accordance with embodiments of the present disclosure, discussed below in connection with FIG. 3. For example, when the network node 110 receives the warning from the UE 120 regarding the first and second positions used by the UE 120 to generate the warning not being reliable, that warning is accounted for in determining that the first and second positions assessed by the network node 110 are also not reliable for use in monitoring and controlling operation of the UE 120.

Furthermore, in some embodiments, the determining of whether or not the first position and the second position of the UE 120 are reliable is further based on the indications of any one or more out of the first and second integrity levels. As mentioned above, an integrity level of a position estimate may be taken into consideration while determining reliability of that position estimate. The integrity level often relates to integrity of devices and systems used to obtain the position estimate, such as, e.g. various sensors.

In various embodiments, when it is determined that the first position and the second position of the UE 120 are not reliable, the method shown in connection with FIG. 2 may again be performed to obtain first and second positions of the UE 120 to determine whether or not the first position and the second position of the UE 120 are reliable. Thus, the network node 110 may continuously perform the method of FIG. 2, as long as the performance of the method is required, e.g. while the UE 120 is operating to perform a certain task.

### Action 206

In various implementations, when one or both of the first position and the second position of the UE 120 in the wireless communications network 100 are determined to be not reliable, the wireless communications network 100, e.g. one or more components in the network 100 or component(s) that control the network 100, may need to be informed accordingly.

In some embodiments, when it is determined that the first position and the second position of the UE 120 are not reliable when the difference between the first position of the UE 120 and the second position of the UE 120 is above the second threshold, the network node 110 sends a warning that the first and second positions of the UE 120 are not reliable. The warning may be sent to any one or more out of the UE 120, an operator of the wireless communications network 100, a human located in the vicinity of the UE 120, a location server of the wireless communications network 100, a controller of a facility, wherein the facility comprises the network node 110 and the UE 120, and wherein the facility is located at least partially indoor. The warning may also be sent to a controller of a drone system, wherein the drone system comprises the network node 110 and the UE 120. In some embodiments, the human may be located in the vicinity of the UE 120, e.g. at a distance from the UE 120 such that a safety of the human may depend on accurate positioning of the UE 120. For example, the human may be located within a few meters, or within a meter, or within less than one meter to the UE 120.

In some embodiments, the warning comprises or is associated with an instruction to modify operation of the UE 120, the instruction comprising any one out of an instruction to change a position of the UE 120, an instruction to halt operation of the UE 120, and an instruction to change a speed of the UE 120. It should be noted that the UE 120 may comprise or may be associated with a robotic device or vehicle, such that the UE 120 may be, for example, mounted on or otherwise coupled to the robotic device or vehicle. Accordingly, in some embodiments, the instruction comprises any one out of an instruction to change a position of the UE 120 and/or a vehicle or device associated with the UE 120, an instruction to halt operation of the UE 120 and/or the vehicle or device, and an instruction to change the speed of the UE 120 and/or the vehicle or device. For example, in an embodiments, the instruction may be to reduce the speed of the UE 120. The device associated with the UE 120 may be any robotic device or equipment, including autonomous or semi-autonomous robots and drones. The vehicle associated with the UE 120 may be any transportation device, such as, e.g., an underground vehicle, a ground vehicle, or an aerial vehicle which may be a drone.

It should be appreciated that the warning that the first and second positions of the UE 120 are not reliable may be sent to any suitable network node, system, or component included in or associated with the wireless communications network 100. The warning may be used by its recipient for adjusting operation of the UE 120 in a suitable manner, depending on the properties of the UE 120, properties of the wireless communications network 100, conditions on the wireless communications network 100, and various other factors, e.g. components that were used to estimate positions of the UE 120. For example, if the UE 120 is a mobile robot that is operating in proximity to a human, and it is determined that the current position of the UE 120 is estimated not reliably, the UE 120 may be instructed to stop its operation, in order to avoid a potential injury to the human. Furthermore, in some embodiments, an audio or another type of signal may additionally or alternatively be generated that informs the human of a potential hazard related to the actual current position of the UE 120 being estimated with less than a required reliability.

In some embodiments, operation of components of the wireless communications network 100 other than the UE 120 may additionally be adjusted when the warning is generated.

In some examples, the determination that the first position and the second position of the UE 120 are not reliable may be an indication of deterioration of certain conditions at the wireless communications network 100 and/or a possible malfunction of one or more components in or associated with the wireless communications network 100. Accordingly, appropriate actions may be taken to investigate possible faulty conditions on the network.

In various circumstances and depending on properties of the network 100, different actions may be taken with respect to the UE 120, and possibly other components forming the wireless communications network 100 and/or associated with the network 100 or UE 120, when it is determined that the first position and the second position of the UE 120 are not reliable, and embodiments of the present disclosure are not limited in this respect.

FIG. 3 shows example embodiments of a method performed by the UE 120 for determining reliability of positions of the UE 120 in the wireless communications network 100.

The method comprises the following actions, which actions may be taken in any suitable order. Optional actions are referred to as dashed boxes in FIG. 3.

In some embodiments, and similar as mentioned above for the network node 110, to be able to determine reliability of UE positions, the UE 120 will collect, such as obtain, at least two different positioning estimations for the same UE 120, which are to be compared. If they have similar values, e.g. the difference is below a threshold, they are determined to be reliable, but if the position values are very different, e.g. the difference is above a threshold, they are determined to be not reliable.

### Action 301

The UE 120 obtains a first position of the UE 120.

In some embodiments the first position of the UE 120 is obtained from the network node 110. The first position may be, e.g. estimated by the network node 110, or the first position may be received by the network node 110 from another network node such as e.g. a base station such as e.g. a gNodeB, a location node such as e.g. a Location Management Function (LMF) node, the cloud, or a positioning server determining the position of the UE 120 through, e.g., fusion of information from network nodes which may utilize different techniques such as, e.g., Wi-Fi, Bluetooth, 4G, 5G, or further implementations. The first position of the UE 120 may e.g. be estimated at least in part by the network node 110 and, in some embodiments, the first position is obtained by the UE 120 from the network node 110.

In some embodiments, the obtaining of the first position of the UE 120 further comprises obtaining an indication of a first integrity level of the first position. An integrity level of a position estimate may comprise one or more numerical or qualitative values, or a combination thereof, which indicate a quality of the estimated first position of the UE 120.

### Action 302

The UE 120 further obtains a second position of the UE 120.

In some embodiments, the second position of the UE 120 may be estimated, e.g. at least in part by the UE 120.

In some embodiments, the second position of the UE 120 is received by the UE 120 from another node, e.g., an LMF node, the cloud, or a positioning server determining the position of the UE 120 through, e.g. fusion of information from network nodes which may utilize different techniques such as, e.g., Wi-Fi, Bluetooth, 4G, 5G, or further implementations.

In some embodiments, any one out of: the first position of the UE 120 is estimated using at least in part the network node 110 and the second position of the UE 120 is estimated using at least in part the UE 120.

In some embodiments, the obtaining of the second position of the UE 120 further comprises obtaining an indication of a second integrity level of the second position. The second integrity level of the position estimate may comprise one or more numerical or qualitative values, or a combination thereof, which indicate a quality of the estimated second position of the UE 120.

### Action 303

The UE 120 may send the second position of the UE 120 to the network node 110.

This may e.g. be in embodiments where the network node 110 is performing the method in parallel with the UE 120 and therefore needs the second position of the UE 120. As an alternative, the network node 110 may be performing the method at other time relative to the UE 120 performing the method. For example, the network node 110 may be performing the method at a time that at least partially overlaps with a time when the UE 120 is performing the method.

In some embodiments, as discussed above in connection with FIG. 2, the network node 110 receives from the UE 120 the second position determined by the UE 120, and the network node 110 may use the second position in determining reliability of positions estimated for the UE 120.

### Action 304

When the network node 110 has determined that the first position and the second position of the UE 120 are not reliable when the difference between the first position of the UE 120 and the second position of the UE 120 is above the second threshold, the UE 120 may further receive, from the network node 110, a warning that the first and second positions of the UE 120 are not reliable.

The warning may be obtained as the UE 120 communicates with the network node 110 regarding positions estimated for the UE 120. The warning may have any suitable form, e.g. it may be a control signal or instruction that is received by the UE 120 from the network node 110. In some embodiments, the UE 120 may further receive the first and second thresholds used by the network node 110 in the determination step (action 205, above).

In some embodiments, the warning may be received not directly from the network node 110 but via another node or component in the wireless communications network 100 which node or component may have received that warning from the network node. For example, in an embodiment, the warning is received from a location server in the wireless communications network 100. In some embodiments, the location server is, comprises, or is associated with a LMF node.

### Action 305

The UE 120 then determines whether or not the first position and the second position of the UE 120 are reliable based, e.g. at least in part, on comparing of the first position of the UE 120 and the second position of the UE 120.

The determining comprises determining that the first position and the second position of the UE 120 are reliable when the difference between the first position of the UE 120 and the second position of the UE 120 is below a first threshold.

The determining further comprises determining that the first position and the second position of the UE 120 are not reliable when the difference between the first position of the UE 120 and the second position of the UE 120 is above a second threshold.

The difference between the first and second positions may be determined in any suitable way. For example, in some embodiments, the distance is a geometric distance between the two position estimates. The distance may be a geometric distance measured in a plane (e.g. in the x-y plane or floor level). In some embodiments, if a relative position is estimated, the distance may be a geometric distance between the two relative position estimates under the assumption that the position was the same at some earlier point in time that is used as reference point.

In some embodiments, the second threshold is greater than the first threshold.

In some embodiments, the first and second thresholds are equal to one another.

Thus, in such embodiments, the determining comprises determining that the first position and the second position of the UE 120 are reliable when the difference between the first position of the UE 120 and the second position of the UE 120 is below a certain threshold, and determining that the first position and the second position of the UE 120 are not reliable when the difference between the first position of the UE 120 and the second position of the UE 120 is above that same threshold.

In some embodiments, the first and second thresholds here are equal to the first and second thresholds, respectively, used in the method performed by the network node 110, see FIG. 2.

In some embodiments, the first and second thresholds here are not equal to the first and second thresholds, respectively, used in the method performed by the network node 110, and may then be referred to as third and fourth thresholds.

In some embodiments, the third threshold is equal to the first threshold used in the method performed by the network node 110, and the fourth threshold is not equal to the second threshold used in the method performed by the network node 110.

In some embodiments, the third threshold is not equal to the first threshold used in the method performed by the network node 110, and the fourth threshold is equal to the second threshold used in the method performed by the network node 110.

In some embodiments, one or both of the first threshold and the second threshold are adjustable based on any one or more out of at least one characteristic of a system comprising the wireless communications network 100 and a required position reliability of the UE 120. In some embodiments, the at least one characteristic relates to a required precision of detection of a position of the UE 120 in the wireless communications network 100.

In some embodiments, the first and second thresholds are adjustable, e.g. dynamically adjustable. Additionally or alternatively, in some embodiments, the first and second thresholds may be manually adjustable, e.g. by an operator of the wireless communications network 100.

Furthermore, in some embodiments, the determining whether or not the first position and the second position of the UE 120 are reliable is further based on the warning received from the network node 110. In this way, the UE 120 takes into consideration results of performance of the method in accordance with embodiments of the present disclosure, discussed above in connection with FIG. 2. For example, when the UE 120 receives the warning from the network node 110 regarding the first and second positions used by the network node 110 to generate the warning not being reliable, that warning may be accounted for in determining that the first and second positions assessed by the UE 120 are also not reliable for use in monitoring and controlling operation of the UE 120. In some embodiments, the UE 120 receives the warning from the network node and may also obtain the first and second thresholds used in the network node determination step (action 205), and the UE 120 may use the same first and second thresholds that the network node 110 has used. In some embodiments, the UE 120 may determine whether or not to use the warning received from the network node 110, based on how similar the first and second thresholds used by the network node 110 are to their counterparts, also referred to as first and second but which may have different values, used by the UE 120.

Furthermore, in some embodiments, the determining of whether or not the first position and the second position of the UE 120 are reliable is further based on the indications of the any one or more out of the first and second integrity levels. As mentioned above, an integrity level of a position estimate may be taken into consideration while determining reliability of that position estimate. The integrity level often relates to integrity of devices and systems used to obtain the position estimate, such as, e.g. various sensors.

In various embodiments, when it is determined that the first position and the second position of the UE 120 are not reliable, the method shown in connection with FIG. 3 may again be performed by the UE 120 to obtain first and second positions of the UE 120 to determine whether or not the first position and the second position of the UE 120 are reliable. Thus, the UE 120 may continuously perform the method of FIG. 3, as long as the performance of the method is required, e.g. during operation of the UE 120 that may perform a certain task.

### Action 306

In various implementations, when one or both of the first position and the second position of the UE 120 in the wireless communications network 100 are determined to be not reliable, the wireless communications network 100, e.g. one or more components in the network 100 or component(s) that control the network 100, need to be informed accordingly.

In some embodiments, when it is determined that the first position and the second position of the UE 120 are not reliable when the difference between the first position of the UE 120 and the second position of the UE 120 is above the second threshold, the UE 120 sends a warning that the first and second positions of the UE 120 are not reliable. The warning may be sent to any one or more out of the network node 110, an operator of the wireless communications network 100, a human in a vicinity to the UE 120, a location server of the wireless communications network 100, a controller of a facility, wherein the facility comprises the network node 110 and the UE 120, and wherein the facility is located at least partially indoor. The warning may also be sent to a controller of a drone system, wherein the drone system comprises the network node 110 and the UE 120.

In some embodiments, the warning comprises or is associated with an instruction to modify operation of the UE 120, the instruction comprising any one out of an instruction to change a position of the UE 120 and/or a vehicle or device associated with the UE 120, an instruction to halt operation of the UE 120 and/or the vehicle or device, and an instruction to change the speed of the UE 120 and/or the vehicle or device. The instruction to change the speed of the UE 120 may be, for example, an instruction to reduce the speed of the UE 120.

It should be appreciated that the warning that the first and second positions of the UE 120 are not reliable may be sent to any suitable network node, system, or component included in or associated with the wireless communications network 100. The warning may be used to adjust operation of the UE 120 in a suitable manner, depending on the properties of the UE 120, properties of the wireless communications network 100, conditions on the wireless communications network 100, and various other factors, e.g. components that were used to estimate positions of the UE 120. For example, if the UE 120 is a mobile robot that is operating in proximity to a human, and it is determined that the current position of the UE 120 is estimated not reliably, the UE 120 may be instructed to stop its operation, in order to avoid a potential injury to the human. Furthermore, in some embodiments, an audio or another type of signal may additionally or alternatively be generated that informs the human of a potential hazard related to the actual current position of the UE 120 being estimated with less than a required reliability.

In various circumstances and depending on properties of the network 100, different actions may be taken with respect to the UE 120, and possibly other components forming the wireless communications network 100 and/or associated with the network 100 or UE 120, when it is determined that the first position and the second position of the UE 120 are not reliable, and embodiments of the present disclosure are not limited in this respect.

The embodiments described in connection with FIGS. 2 and 3 will now be further explained and exemplified below. The embodiments below may be combined with any suitable embodiment above.

### Reliability of an Estimated Position

As mentioned above, reliability of an estimated position and a position being reliable, when used herein, means that the position is determined with sufficient precision to reflect an actual, physical position of the UE 120. This may be performed such that the determined position is appropriate for use in controlling operation of the UE 120 in the wireless communications network 100. In other words, in various example embodiments herein, the reliable position is an estimated position of the UE 120 which is close to the actual position of the UE 120 and which is sufficiently accurate for a task performed by the UE 120, requirements of the wireless communications network 100, a type of a facility in which the wireless communications network 100, and other factors. A reliable position may be trusted in making decisions regarding operation of the UE 120, which decisions may be made automatically, manually, or via a combination of an automatic and manual control.

For example, if the wireless communications network 100 is or comprises a facility such as a storage warehouse and the UE 120 comprises or is associated with an autonomous or semi-autonomous robot that selects, sorts, moves, or otherwise handles goods, a position of the UE 120 may be determined to be reliable if it is estimated to have an error which is less than a threshold, where the threshold may be from about 10 cm to about 1 meter, or about 1 meter, or from 1 meter to several meters, depending on the situation or use case where the estimated positions are used. For example, a positioning accuracy required when operating an automated guided vehicle (AGV) in an area with obstacles and/or other AGVs present may be in the order of decimeters, based on which a first threshold may be in the order of 10 cm, e.g. from about 5 to about 15 cm. On the other hand, for a use-case such as, e.g. traffic control in an underground mine, it may be sufficient to know if a mining truck is approaching, and a positioning accuracy in the order of tens of meters can be sufficient. In this case, the first threshold can be in the order of tens of meters. A vehicle-to-everything (V2X) environment also may require an accuracy of a few decimetres. As another example, if the facility includes a robot operating in proximity to a human, and an erroneous estimation of the robot's position may endanger human life, a higher precision of the position estimation may be required, and a position is reliable if it is estimated with a precision of, e.g., less than 1 meter, or less than 50 cm, or less than 10 cm. Thus, a reliability of a position estimated for a UE may be different depending on the environment, such as a facility, in which the UE operates, tasks performed by the UE, other entities in the environment, and various other factors. In some embodiments, values of the reliability and one or more thresholds are determined for each facility or system, which may be done prior to initiating operation of the UE. In some embodiments, additionally or alternatively, the values may be adjustable, e.g. dynamically adjustable based on current actors and situation in the facility or other system in which the UE operates.

In addition, it should be noted that, as used herein, a reliability refers to both the first and second positions of the UE 120 which are compared and determined to be reliable or not reliable. In embodiments in accordance with the present disclosure, this means that both the first and second positions are considered reliable or not, based on their difference. However, it should be appreciated that one of the first and second positions may be more accurate, e.g. it may have a higher integrity level, than another one of the first and second positions. But, for the purposes of the present disclosure, the first and second positions are not assessed separately regarding their reliability, though their respective integrity levels may contribute to the determination of the reliability of the first and second positions of the UE 120.

### Obtaining Two or More Different Positioning Estimates for the Same UE 120

In some embodiments, to be able to determine reliability of UE 120 positions according to embodiments herein, the network node 110 will collect, such as obtain, two different positioning estimates for the same UE 120, which are to be compared, see FIG. 2. Similarly, the UE 120 will collect, such as obtain, two different estimates for its positioning which estimates are to be compared, see FIG. 3.

If the first and second positions have similar values, e.g. below a first threshold, they are determined to be reliable, but if the position values are very different, e.g. above a second threshold, they are determined to be not reliable.

Two different positioning estimations may mean that the positions are estimated using at least two methods that differ in components used to estimate the positions and/or that use different position estimation techniques. In some embodiments described herein, these different methods are sometimes referred to as a network-based positioning and a UE-based positioning. It should be appreciated however that such terminology only generally describes that the two methods are different at least in some respect, such that more than one position is estimated for a UE, thereby redundancy in position estimation is achieved.

In some embodiments, a network-based positioning comprises estimating a position, referred to herein as a first position of the UE 120 using a time-of-arrival (ToA)-based method, e.g., an Uplink Time Difference of Arrival (UL-TDoA) based method, angle-of-arrival (AoA)-based method, or a combination thereof. Other network-based positioning methods that also may be utilized are based on round-trip time (RTT) measurements, received power measurements, possibly combined with fingerprinting solutions, or timing advance measurements.

In some embodiments, a UE-based positioning comprises estimating a position, referred to herein as a second position of the UE 120 by the UE 120 and/or by components in a system in which the UE 120 operates. Thus, such positioning may comprise one or more out of cellular-based positioning, Global Navigation Satellite Systems (GNSS)-based positioning, and positioning using one or more sensors such as, e.g. inertial sensors such that Inertial Motion Units (IMUs), barometric pressure sensors, video cameras, laser sensors, magnetic position sensors, Bluetooth signal strength sensors, Wi-Fi signal strength sensors, electromagnetic field sensing sensors, etc. Sensors that acquire measurements which may be used for UE positioning may be disposed externally to the UE, for example, in various locations of the wireless communications network. In some embodiments, the UE-based positioning method is independent of 3GPP radio access technologies (RAT).

In embodiments of the present disclosure, a method for determining reliability of positions of the UE 120 may be performed in the network node 110, in the UE 120, in both the network node 110 and the UE 120, e.g. in parallel, or in any other node in the wireless communications network 100, or in any combination of one or more thereof.

In some embodiments, the network node 110 may obtain the first and second positions for more than one UE, such that the network node 110 may determine reliability of positions of more than one UE in the wireless communications network 100.

In some embodiments, the UE 120 may obtain the first position from more than one network node, such that the UE 120 may determine reliability of its position estimate using more than one first position, with each of the first positions being obtained by the UE 120 from a different network node in the wireless communications network 100.

Accordingly, the method in accordance with the present disclosure provides redundancy in estimating a position, e.g. a current position, of the UE 120 in the wireless communications network 100. The use of redundancy significantly reduces the risk of an erroneous position being used for decisions by the UE 120 such as, e.g. an autonomous vehicle or any other type of a UE.

In some embodiments, the position of the UE 120 is estimated with cellular ToA by both the UE 120 and the network node 110, which provides some redundancy. The radio propagation environment may however be the same in both up- and downlink, and it is thus desirable to use different positioning methods to increase redundancy.

In some embodiments, the position of the UE 120 is estimated with ToA by the UE and with AoA by the network node 110, which provides good redundancy. The radio propagation environment is the same in both up- and downlink but the positioning methods are different, such that the risk of obtaining identical erroneous position estimates is significantly reduced.

In some embodiments, local sensors, e.g. an IMU or dead reckoning associated with the UE 120 are used for the UE-based position estimate. The network node 110 may determine the estimate of the position of the UE 120 in any suitable manner. This approach introduces a different positioning method that does not depend on the radio propagation environment at all, which may significantly reduce the risk of obtaining identical erroneous position estimates.

In some embodiments, the position of the UE 120 is estimated using GNSS by the UE 120 and using network-based cellular positioning methods by the network node 110. Different radio channels are used for the position estimation which will significantly reduce the risk of obtaining identical erroneous position estimates.

### First and Second Thresholds

The first and second thresholds may be selected in various ways. In some embodiments, the first and second thresholds are selected based on requirements of the wireless communications network 100 regarding a precision of estimation of positions of the UE 120, as well as other devices in the wireless communications network 100. In some embodiments, selection of the first and the second thresholds depends both on the required precision of the position estimate as well as the required reliability of the position estimate being within this limit. If the required precision of the position estimate is desired to be achieved with a high reliability, e.g. with a reliability of at least 90%, or at least 95%, or at least 99.9%, or at least 99.99%, the first and second thresholds may be selected to be significantly lower than the required precision of the position estimate. The selection of the first and second thresholds in relation to the required reliability may also take into account the integrity levels of the first position and the second position. It should be appreciated, however, that any suitable threshold value may be used additionally or alternatively, as embodiments of the present disclosure are not limited in this respect. The magnitude of the thresholds will depend on a type and precision of operations performed by the UE 120, other entities in the system comprising the UE 120, and any other factors.

The first and second thresholds may have any suitable values. As an example, the first threshold may be close to but less than 1 meter, e.g. 90 cm, 95 cm, or 99 cm, whereas the second threshold may be close to but greater than 1 meter, e.g. 105 cm, 109 cm, or 110 cm. As another example, in embodiments in which the first and second thresholds are equal, such threshold may be 1 meter or about 1 meter, e.g. from 90 cm to 110 cm. In some embodiments, the first and second thresholds may be below 1 meter, e.g. less than 50 cm, or 50 cm, or 40 cm, or 30 cm, or 20 cm, or 10 cm, or less than 10 cm. In some embodiments, e.g., in environments in which a rough position estimate is sufficient, the first and second thresholds may be more than 1 meter.

In some embodiments, the first position and the second position of the UE 120 are determined to be not reliable when the difference between the first position and the second position is above the first threshold. In some embodiments, the first position and the second position of the UE 120 are determined to be not reliable when the difference between the first position and the second position is equal to or above the first threshold.

In some embodiments, the first position and the second position of the UE 120 are determined to be reliable when the difference between the first position and the second position is below the second threshold and above or equal to the first threshold. In some embodiments, the first position and the second position of the UE 120 are determined to be reliable when the difference between the first position and the second position is equal to or below the second threshold and equal to or above the first threshold.

Being below the first threshold, when used herein, may also comprise being below or equal to the first threshold. Being above the second threshold, when used herein, may also comprise being above or equal to the second threshold.

In some embodiments, the first and second thresholds, which may be equal to one another, may either be fixed, e.g. predetermined, or they may be adjustable or adaptive. Adjustable thresholds may be calculated based on, e.g. a risk analysis.

In some embodiments, the first and second thresholds may be dynamically adjustable, such that one or both of the first and second thresholds is adjusted as the UE 120 operates in the wireless communications network 100, e.g., to perform a task.

The at least one characteristic of the system comprising the wireless communications network 100 may comprise a presence of a human in the wireless communications network 100 and/or proximity of the human to the UE 120 which may be, e.g. a moving robot. In such cases, the first and second thresholds may be low such that little tolerance for errors is allowed. When the human is no longer present in the system, the thresholds may be increased, as a human safety is not at risk at that point. The risk analysis may also include tasks requiring extra precision. For example, when an Automated Guided Vehicle (AGV) is moving in an area where high precision is required, e.g. when parking or when driving in close proximity to a human or other AGVs, the thresholds may be lower than when the AGV is moving in a large open area.

### Determining a Position of the UE 120

As mentioned above, first and second positions may be estimated in embodiments of the present disclosure using various approaches.

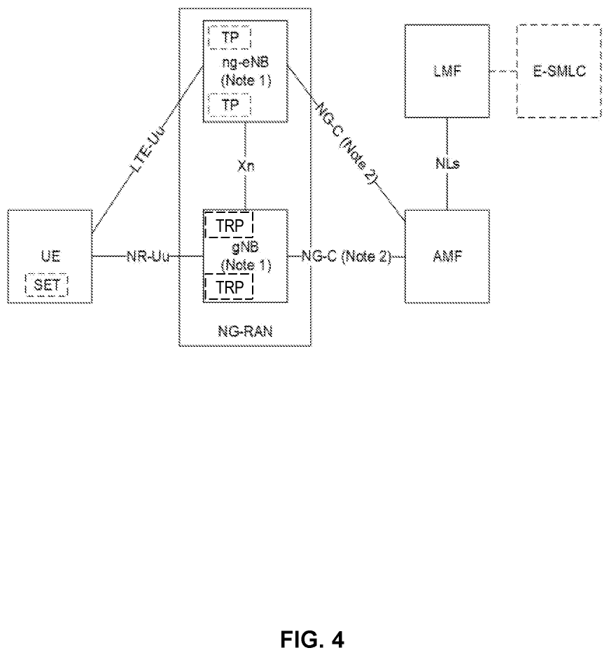

Positioning has been a topic in LTE standardization since 3GPP Release 9. The primary objective is to fulfil regulatory requirements for emergency call positioning. Positioning in NR, which is derived from the 4G positioning architecture, has been proposed to be supported by an architecture shown in FIG. 4. A UE shown in FIG. 4 may be the UE 120, or any other UE.

A Location Management Function (LMF) node is the location node in NR. The LMF receives measurements and assistance information from the NG-RAN and the mobile device, such as, e.g. the UE 120, via an Access and Mobility management Function (AMF) over NLs interface to compute the position of the UE. There are interactions between the location node and the gNodeB, such as the network node 110 via an NR Positioning Protocol A (NRPPa) protocol. The NRPPa protocol was introduced to carry positioning information and measurements between NG-RAN and LMF over the next generation control plane interface (NG-C). The interactions between the gNodeB, such as the network node 110, and the device, such as the UE 120, are supported via the Radio Resource Control (RRC) protocol. FIG. 4 discloses an architecture according to 3GPP NG-RAN Release-15 LCS Protocols, wherein:

TP means Transmission Point in the LTE, whereas TRP means Transmission Reception Point in NR gNB.

SET means SUPL Enabled Terminal (SUPL Secure User Plane Location). This is a wireless device or user equipment/terminal supporting SUPL.

LTE Uu is the radio interface that connects the UEs to the eNodeBs and the eNodeB with the UE. It handles all the signalling messages between the eNodeB and the MME as well as the data traffic between the UE and the S-GW.

NR Uu is the interface for cellular communication between device and base stations, similar to the definition for LTE now adopted for NR.

Xn is the interface defined between two NG-RAN nodes.

E-SMLC means Evolved Serving Mobile Location Centre.

AMF means Access Mobility Function.

Note 1: The gNB and ng-eNB may not always both be present.

Note 2: When both the gNB and ng-eNB are present, the NG-Core (C) interface is only present for one of them.

In the legacy LTE standards, the following techniques are supported:
Enhanced Cell ID. Essentially cell ID information to associate the device to the serving area of a serving cell, and then additional information to determine a finer granularity position.
Assisted Global Navigation Satellite System (GNSS). GNSS information retrieved by the device, supported by assistance information provided to the device from E-SMLC.
Observed Time Difference of Arrival (OTDOA). The device estimates the time difference of reference signals from different base stations and sends to the E-SMLC for multilateration.
Uplink Time Difference of Arrival (UTDOA). The device is requested to transmit a specific waveform that is detected by multiple location measurement units (e.g. an eNB) at known positions. These measurements are forwarded to E-SMLC for multilateration.
Sensor methods such as Barometric pressure sensor which provides vertical position of the device and Inertial Motion Unit (IMU) which provides displacement.

All of these methods are also being standardized for NR in 3GPP Release 15 (limited functionality) and Release 16 and are planned to be enhanced in Release 17.

The positioning modes may be categorized, e.g. in below three areas:
UE-Assisted: The UE, such as the UE 120, performs measurements with or without assistance from the network and sends these measurements to the E-SMLC where the position calculation may take place.
UE-Based: The UE, such as the UE 120, performs measurements and calculates its own position with assistance from the network.
Standalone: The UE, such as the UE 120, performs measurements and calculates its own without network assistance.

Emerging applications relying on high-precision positioning technology in autonomous applications, e.g., automotive, has brought with it the need for high integrity and reliability in addition to high accuracy. The 5G service requirements specified in 3GPP TS 22.261 include the need to determine the reliability, and the uncertainty or confidence level, of the position-related data.

It should be appreciated that FIG. 4 illustrates the architecture that supports positioning according to 3GPP only to illustrate how one or both of the first and second positions may be determined in accordance with embodiments of the present disclosure. Various other methods, including a UE-based method, e.g. a method involving sensor measurements, may be used additionally or alternatively.

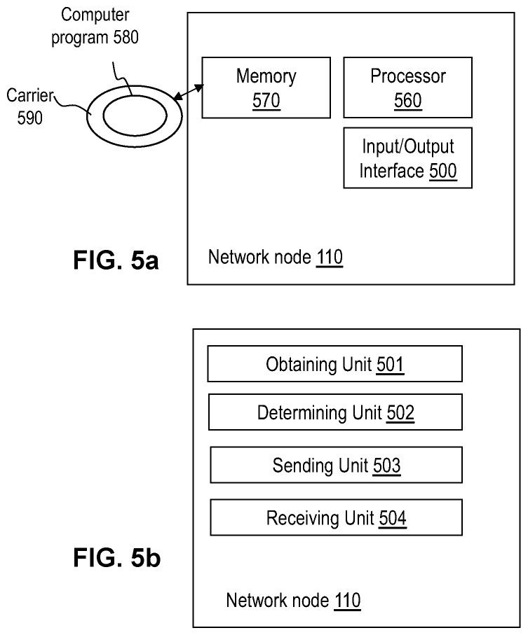

To perform the method actions above, the network node 110 is configured to determine reliability of positions of the UE 120 in the wireless communications network 100. The network node 110 may comprise an arrangement depicted in FIGS. 5a and 5b.

As shown in FIG. 5a, the network node 110 may comprise an input and output interface 500 configured to communicate with UEs such as the UE 120. The input and output interface 500 may comprise a wireless receiver (not shown) and a wireless transmitter (not shown).

The network node 110 may be configured to, e.g. by means of an obtaining unit 501 in the network node 110, obtain a first position of the UE 120. The first position of the UE 120 is adapted to be estimated, e.g. using at least in part, the network node 110.

In some embodiments, the network node 110 may further be configured to, e.g. by means of the obtaining unit 501 in the network node 110, obtain the first position of the UE 120 by further obtaining an indication of a first integrity level of the first position.

The network node 110 may further be configured to, e.g. by means of the obtaining unit 501 in the network node 110, obtain a second position of the UE 120. The second position of the UE 120 is adapted to be estimated, e.g. using at least in part, the UE 120.

In some embodiments, the network node 110 may further be configured to, e.g. by means of the obtaining unit 501 in the network node 110, obtain the second position of the UE 120 by further obtaining an indication of a second integrity level of the second position.

The network node 110 may further be configured to, e.g. by means of a determining unit 502 in the network node 110, determine whether or not the first position and the second position of the UE 120 are reliable based, e.g., at least in part, on comparing of the first position of the UE 120 and the second position of the UE 120. The comparison is performed by determining that the first position and the second position of the UE 120 are reliable when the difference between the first position of the UE 120 and the second position of the UE 120 is below a first threshold and determining that the first position and the second position of the UE 120 are not reliable when the difference between the first position of the UE 120 and the second position of the UE 120 is above a second threshold.

In some embodiments, the second threshold is the same as the first threshold. In some embodiments, the second threshold is different than the first threshold.

One or both of the first and second thresholds may be adjustable. In some embodiments, one or both of the first threshold and the second threshold are adjustable based on any one or more out of at least one characteristic of a system comprising the wireless communications network 100. The at least one characteristic may relate to a required precision of detection of a position of the UE 120 in the wireless communications network 100, and a required position reliability of the UE 120.

In some embodiments, e.g., in which the network mode 110 is configured to obtain any one or more out of the indication of the first integrity level of the first position of the UE 120, and the indication of the second integrity level of the second position, the network node 110 may further be configured to, e.g. by means of the determining unit 502, determine whether or not the first position and the second position of the UE 120 are reliable by further basing it on the indications of the any one or more out of the first and second integrity levels.

In some embodiments, the network node 110 may further be configured to, e.g. by means of a sending unit 503 in the network node 110, send to the UE 120 the first position of the UE 120.

In some embodiments, the network node 110 may further be configured to, e.g. by means of the sending unit 503 in the network node 110, when it is determined that the first position and the second position of the UE 120 are not reliable when the difference between the first position of the UE 120 and the second position of the UE 120 is above the second threshold, send a warning that the first and second positions of the UE 120 are not reliable.

The warning may be adapted to be sent to any one or more out of: The UE 120, an operator of the wireless communications network 100, a human located in the vicinity of the UE 120, a location server of the wireless communications network 100, and a controller of a facility. The facility may comprise the network node 110 and the UE 120, and the facility may be located at least partially indoor. In some embodiments, the warning is further adapted to be sent to a controller of a drone system, wherein the drone system comprises the network node 110 and the UE 120. The warning may be adapted to comprise or be associated with an instruction to modify operation of UE 120. The instruction may comprise any one out of an instruction to change a position of the UE 120 and/or a vehicle or device associated with the UE 120, an instruction to halt operation of the UE 120 and/or the vehicle or device, and an instruction to change the speed of the UE 120 and/or the vehicle or device.

In some embodiments, the network node 110 may further be configured to, e.g. by means of a receiving unit 504 in the network node 110, when the UE 120 has determined that the first position and the second position of the UE 120 are not reliable when the difference between the first position of the UE 120 and the second position of the UE 120 is above the second threshold, receive, from the UE 120, a warning that the first and second positions of the UE 120 are not reliable. Furthermore, in some embodiments, the network node 110 may further be configured to, e.g. by means of the receiving unit 504, receive from the UE 120 the first and second thresholds, or one threshold if the first and second thresholds are the same, used by the UE 120 to determine whether or not the first and second positions are reliable.

In some embodiments, the network node 110 may further be configured to, e.g. by means of the determining unit 502 in the network node 110, determine whether or not the first position and the second position of the UE 120 are reliable further based on the warning received e.g. by means of the receiving unit 504 from the UE 120. In some embodiments, the network node 110 may further be configured to, e.g. by means of the determining unit 502, use one or more of the first threshold, the second threshold, and the warning received from the UE 120, in the determination of whether or not the first position and the second position of the UE 120.

The embodiments herein may be implemented through a respective processor or one or more processors, such as the processor 560 of a processing circuitry in the network node 110 depicted in FIG. 5b, together with respective computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 570 comprising one or more memory units. The memory 570 comprises instructions executable by the processor in network node 110. The memory 570 is arranged to be used to store e.g. information, indications, data, configurations, and applications to perform the methods herein when being executed in the network node 110.

In some embodiments, a computer program 580 comprises instructions, which when executed by the respective at least one processor 560, cause the at least one processor of the network node 110 to perform the actions above.

In some embodiments, a respective carrier 590 comprises the respective computer program 580, wherein the carrier 590 is one of an electronic signal, an optical signal, an electromagnetic signal, a magnetic signal, an electric signal, a radio signal, a microwave signal, or a computer-readable storage medium.

Those skilled in the art will appreciate that the units in the network node 110 described above may refer to a combination of analog and digital circuits, and/or one or more processors configured with software and/or firmware, e.g. stored in the network node 110, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

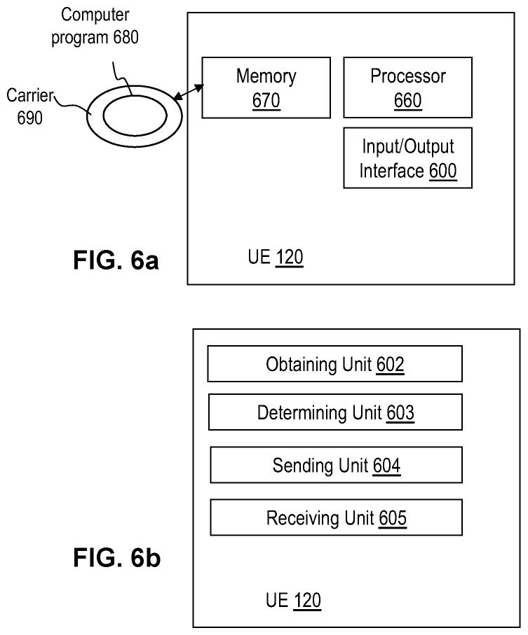

To perform the method actions above, the UE 120 is configured to determine reliability of positions of the UE 120 in the wireless communications network 100. The UE 120 may comprise an arrangement depicted in FIGS. 6a and 6b.

As shown in FIG. 6a, the UE 120 may comprise an input and output interface 600 configured to communicate with network nodes such as the network node 110. The input and output interface 600 may comprise a wireless receiver (not shown) and a wireless transmitter (not shown).

The UE 120 may be configured to, e.g. by means of an obtaining unit 601 in the UE 120, obtain a first position of the UE 120. The first position of the UE 120 is adapted to be estimated using, e.g. at least in part, the network node 110.

In some embodiments, the UE 120 may further be configured to, e.g. by means of the obtaining unit 601 in the UE 120, obtain the first position of the UE 120 by further obtaining an indication of a first integrity level of the first position.

The UE 120 may further be configured to, e.g. by means of the obtaining unit 601 in the UE 120, obtain a second position of the UE 120. The second position of the UE 120 is adapted to be estimated using, e.g. at least in part, the UE 120.

In some embodiments, the UE 120 may further be configured to, e.g. by means of the obtaining unit 601 in the UE 120, obtain the second position of the UE 120 by further obtaining an indication of a second integrity level of the second position.

The UE 120 may further be configured to, e.g. by means of a determining unit 602 in the UE 120, determine whether or not the first position and the second position of the UE 120 are reliable based, e.g., at least in part, on comparing of the first position of the UE 120 and the second position of the UE 120. The comparison is performed by determining that the first position and the second position of the UE 120 are reliable when the difference between the first position of the UE 120 and the second position of the UE 120 is below a first threshold and determining that the first position and the second position of the UE 120 are not reliable when the difference between the first position of the UE 120 and the second position of the UE 120 is above a second threshold.

In some embodiments, the second threshold is the same as the first threshold. In some embodiments, the second threshold is different than the first threshold.

In some embodiments, one or both of the first and second thresholds may be adjustable. In some embodiments, one or both of the first threshold and the second threshold are adjustable based on any one or more out of at least one characteristic of a system comprising the wireless communications network 100. The at least one characteristic may relate to a required precision of detection of a position of the UE 120 in the wireless communications network 100, and a required position reliability of the UE 120.

In some embodiments, e.g., in which the UE 120 is configured to obtain any one or more out of the indication of the first integrity level of the first position of the UE 120, and the indication of the second integrity level of the second position, the UE 120 may further be configured to, e.g. by means of the determining unit 602, determine whether or not the first position and the second position of the UE 120 are reliable by further basing it on the indications of the any one or more out of the first and second integrity levels.

In some embodiments, the UE 120 may further be configured to, e.g. by means of a sending unit 603 in the UE 120, send to the network node 110 the second position of the UE 120.

In some embodiments, the UE 120 may further be configured to, e.g. by means of the sending unit 603 in the UE 120, when it is determined that the first position and the second position of the UE 120 are not reliable when the difference between the first position of the UE 120 and the second position of the UE 120 is above the second threshold, send a warning that the first and second positions of the UE 120 are not reliable.

The warning may be adapted to be sent to any one or more out of: An operator of the wireless communications network 100, a human located in the vicinity of the UE 120, a location server of the wireless communications network 100, and a controller of a facility. The facility may comprise the network node 110 and the UE 120, and the facility may be located at least partially indoor. In some embodiments, the warning is further adapted to be sent to a controller of a drone system, wherein the drone system comprises the network node 110 and the UE 120. The warning may be adapted to comprise or be associated with an instruction to modify operation of UE 120. The instruction may comprise any one out of an instruction to change a position of the UE 120 and/or an associated vehicle or device, an instruction to halt operation of the UE 120 and/or an associated vehicle or device, and an instruction to change a speed of the UE 120 and/or an associated vehicle or device.

In some embodiments, the UE 120 may further be configured to, e.g. by means of a receiving unit 604 in the UE 120, when the network node 110 has determined that the first position and the second position of the UE 120 are not reliable when the difference between the first position of the UE 120 and the second position of the UE 120 is above the second threshold, receive, from the network node 110, a warning that the first and second positions of the UE 120 are not reliable. In some embodiments, the warning comprises or is associated with an instruction to modify operation of the UE 120. The instruction to modify operation of UE 120 may comprise any one out of: an instruction to change a position of the UE 120 and/or a vehicle or device associated with the UE 120, an instruction to halt operation of the UE 120 and/or the vehicle or device, and an instruction to change the speed of the UE 120 and/or the vehicle or device. Furthermore, in some embodiments, the UE 120 may further be configured to, e.g. by means of the receiving unit 604, receive from the network node 110 the first and second thresholds, or one threshold if the first and second thresholds are the same, used by the network node 110 to determine whether or not the first and second positions are reliable. The UE 120 may then use the first and second thresholds and the warning in its determination of the reliability of the first and second positions. Alternatively, the UE 120 may account for the first and second thresholds in some other manner, while taking into consideration the warning received from the network node 110.

In some embodiments, the UE 120 may further be configured to, e.g. by means of the determining unit 602 in the UE 120, determine whether or not the first position and the second position of the UE 120 are reliable further based on the warning received e.g. by means of the receiving unit 604 from the network node 110.

The embodiments herein may be implemented through a respective processor or one or more processors, such as the processor 660 of a processing circuitry in the UE 120 depicted in FIG. 6b, together with respective computer program code for performing the functions and actions of the embodiments herein. The program code mentioned above may also be provided as a computer program product, for instance in the form of a data carrier carrying computer program code for performing the embodiments herein when being loaded into the UE 120. One such carrier may be in the form of a CD ROM disc. It is however feasible with other data carriers such as a memory stick. The computer program code may furthermore be provided as pure program code on a server and downloaded to the UE 120.

The UE 120 may further comprise a memory 670 comprising one or more memory units. The memory 670 comprises instructions executable by the processor in UE 120. The memory 670 is arranged to be used to store e.g. information, indications, data, configurations, and applications to perform the methods herein when being executed in the UE 120.

In some embodiments, a computer program 680 comprises instructions, which when executed by the respective at least one processor 660, cause the at least one processor of the UE 120 to perform the actions above.

In some embodiments, a respective carrier 690 comprises the respective computer program 680, wherein the carrier 690 is one of an electronic signal, an optical signal, an electromagnetic signal, a magnetic signal, an electric signal, a radio signal, a microwave signal, or a computer-readable storage medium.

Those skilled in the art will appreciate that the units in the UE 120 described above may refer to a combination of analog and digital circuits, and/or one or more processors configured with software and/or firmware, e.g. stored in the UE 120, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

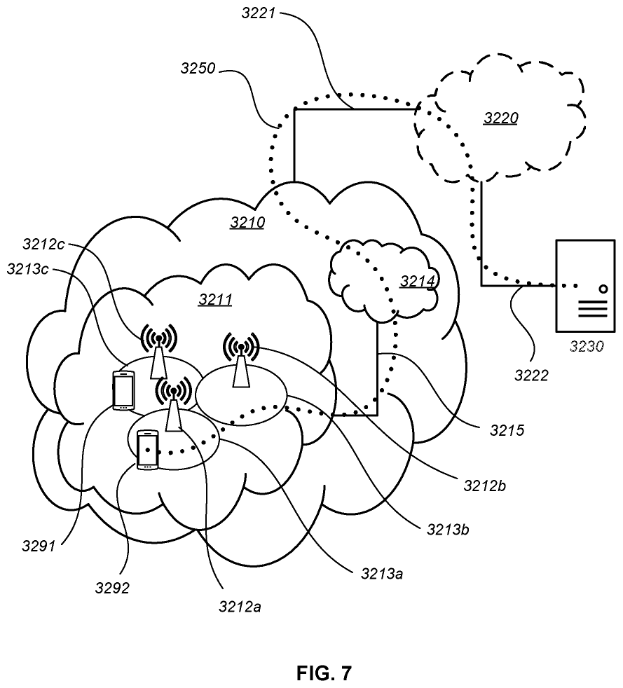

With reference to FIG. 7, in accordance with an embodiment, a communication system includes a telecommunication network 3210, such as a 3GPP-type cellular network, e.g. the wireless communications network 100, which comprises an access network 3211, such as a radio access network, and a core network 3214. The access network 3211 comprises a plurality of base stations 3212a, 3212b, 3212c, e.g. the network node 110, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A user equipment (UE) such as a Non-AP STA 3291, e.g. the UE 120 in some embodiments, located in coverage area 3213c is configured to wirelessly connect to, or be paged by, the corresponding base station 3212c. A second UE 3292, such as a Non-AP STA, e.g. the UE 120 in some embodiments, in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

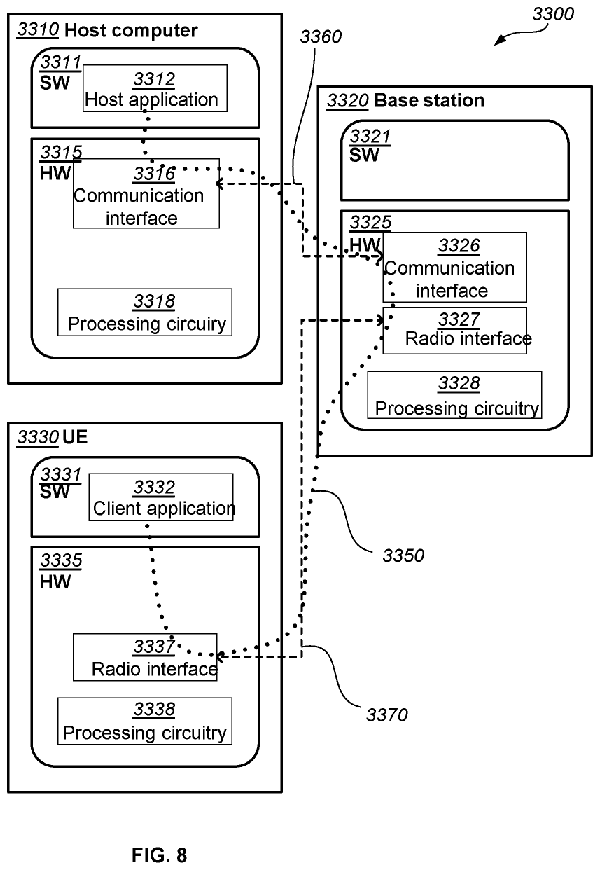

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 8) served by the base station 3320. The communication interface 3326 may be configured to facilitate a connection 3360 to the host computer 3310. The connection 3360 may be direct or it may pass through a core network (not shown in FIG. 8) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 7, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

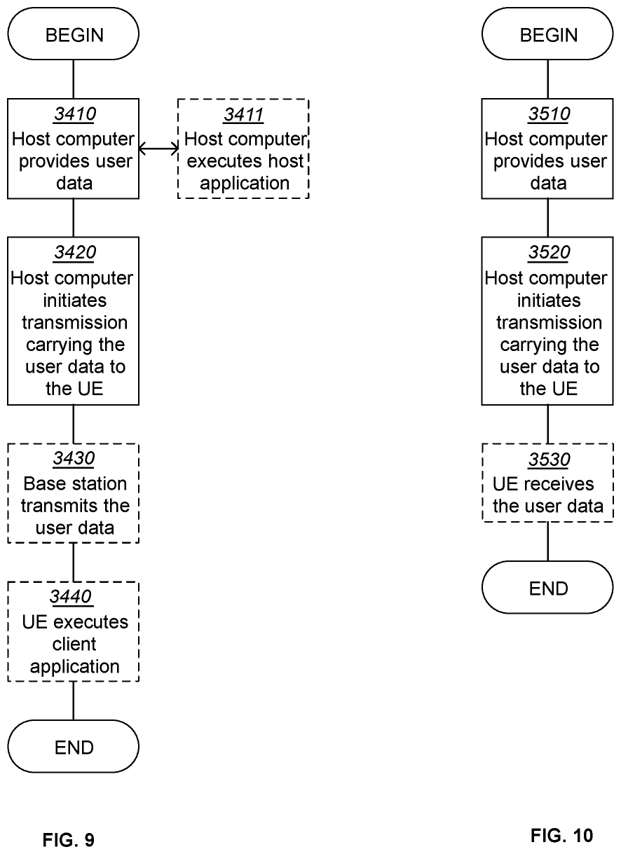

FIG. 9 is a flowchart illustrating a method implemented in a communication system, in accordance with one embodiment. The communication system includes a host computer, a base station such as a AP STA, and a UE such as a Non-AP STA which may be those described with reference to FIG. 8 and FIG. 7. For simplicity of the present disclosure, only drawing references to FIG. 9 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 10 is a flowchart illustrating a method implemented in a communication system, in accordance with one embodiment. The communication system includes a host computer, a base station such as a AP STA, and a UE such as a Non-AP STA which may be those described with reference to FIG. 7 and FIG. 8. For simplicity of the present disclosure, only drawing references to FIG. 10 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

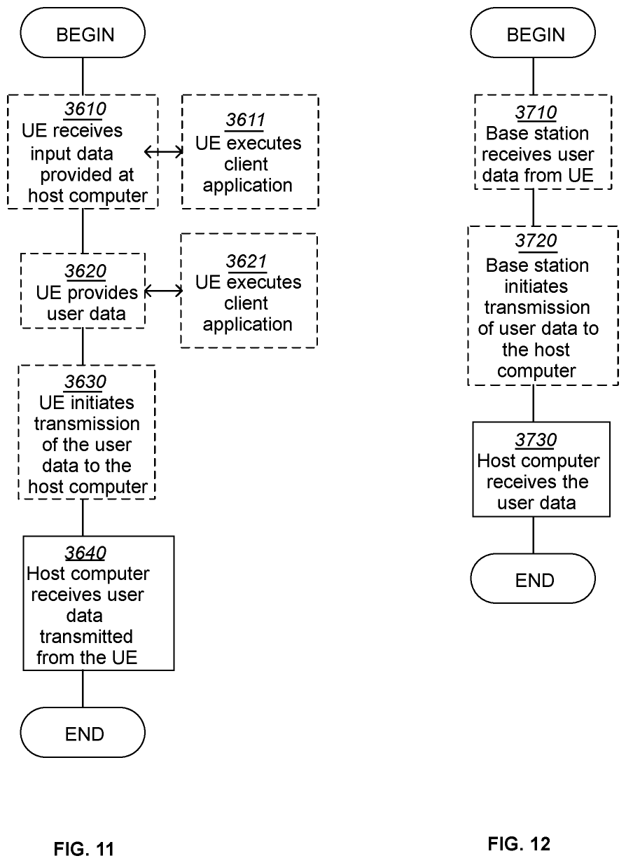

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 11 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 12 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above-described preferred embodiments. Various alternatives, modifications and equivalents may be used.

1. A method performed by a network node for determining reliability of positions of a User Equipment, UE, in a wireless communications network, the method comprising:
obtaining a first position of the UE;
obtaining a second position of the UE; and
determining whether or not the first position and the second position of the UE are reliable based on comparing of the first position of the UE, and the second position of the UE by:
determining that the first position and the second position of the UE are reliable when the difference between the first position of the UE and the second position of the UE is below a first threshold; and
determining that the first position and the second position of the UE are not reliable when the difference between the first position of the UE and the second position of the UE is above a second threshold.

2. The method according to claim 1, wherein any one or more out of:
the obtaining the first position of the UE further comprises obtaining an indication of a first integrity level of the first position; and
the obtaining the second position of the UE further comprises obtaining an indication of a second integrity level of the second position; and wherein
the determining whether or not the first position and the second position of the UE are reliable is further based on the indications of the any one or more out of the first and second integrity levels.

3. The method according to claim 1, further comprising:
when it is determined that the first position and the second position of the UE are not reliable when the difference between the first position of the UE and the second position of the UE is above the second threshold, sending a warning that the first and second positions of the UE are not reliable, which warning is sent to any one or more out of:
the UE;
an operator of the wireless communications network;
a human located in the vicinity of the UE, a location server of the wireless communications network;
a controller of a facility, wherein the facility comprises the network node and the UE, and wherein the facility is located at least partially indoor; and
a controller of a drone system, wherein the drone system comprises the network node and the UE;
wherein the warning comprises or is associated with any one or more out of:
an instruction to modify operation of UE, the instruction comprising any one out of: an instruction to change a position of the UE and/or a vehicle or device associated with the UE, an instruction to halt operation of the UE and/or the vehicle or device, and an instruction to change the speed of the UE and/or the vehicle or device.

4. The method according to claim 1, further comprising:
sending, to the UE, the first position of the UE.

5. The method according to claim 4, further comprising:
when the UE has determined that the first position and the second position of the UE are not reliable when the difference between the first position of the UE and the second position of the UE is above the second threshold, receiving, from the UE, a warning that the first and second positions of the UE are not reliable.

6. The method according to claim 5, wherein the determining whether or not the first position and the second position of the UE are reliable is further based on the warning received from the UE.

7. The method according to claim 1, wherein any one out of: the first position of the UE is estimated using at least in part the network node and the second position of the UE is estimated using at least in part the UE.

8. The method according to claim 2, wherein one or both of the first threshold and the second threshold are adjustable based on any one or more out of:
at least one characteristic of a system comprising the wireless communications network, wherein the at least one characteristic relates to a required precision of detection of a position of the UE in the wireless communications network;
at least one of the first integrity level of the first position and the second integrity level of the second position; and
a required position reliability of the UE.

9. (canceled)

10. (canceled)

11. A method performed by a User Equipment, UE, for determining reliability of positions of the UE in a wireless communications network, the method comprising:
obtaining a first position of the UE;
obtaining a second position of the UE; and
determining whether or not the first position and the second position of the UE are reliable based on comparing of the first position of the UE, and the second position of the UE by:
determining that the first position and the second position of the UE are reliable when the difference between the first position of the UE and the second position of the UE is below a first threshold; and
determining that the first position and the second position of the UE are not reliable when the difference between the first position of the UE and the second position of the UE is above a second threshold.

12. The method according to claim 11, wherein any one or more out of:
the obtaining the first position of the UE further comprises obtaining an indication of a first integrity level of the first position; and
the obtaining the second position of the UE further comprises obtaining an indication of a second integrity level of the second position; and wherein
the determining whether or not the first position and the second position of the UE are reliable is further based on the indications of the any one or more out of the first and second integrity levels.

13. The method according to claim 11, further comprising:
when it is determined that the first position and the second position of the UE are not reliable when the difference between the first position of the UE and the second position of the UE is above the second threshold, sending a warning that the first and second positions of the UE are not reliable, which warning is sent to any one or more out of:
the network node;
an operator of the wireless communications network;
a human located in the vicinity of the UE;
a location server of the wireless communications network;
a controller of a facility, wherein the facility comprises the network node and the UE, and wherein the facility is located at least partially indoor; and
a controller of a drone system, wherein the drone system comprises the network node and the UE.

14. The method according to claim 11, further comprising:
sending, to the network node, the second position of the UE.

15. The method according to claim 14, further comprising:
when the network node has determined that the first position and the second position of the UE are not reliable when the difference between the first position of the UE and the second position of the UE is above the second threshold, receiving, from the network node, a warning that the first and second positions of the UE are not reliable, wherein the warning comprises or is associated with any one or more out of:
an instruction to modify operation of UE, the instruction comprising any one out of: an instruction to change a position of the UE and/or a vehicle or device associated with the UE, an instruction to halt operation of the UE and/or the vehicle or device, and an instruction to change the speed of the UE and/or the vehicle or device.

16. The method according to claim 15, wherein the determining whether or not the first position and the second position of the UE are reliable is further based on the warning received from the network node.

17. The method according to claim 11, wherein any one out of: the first position of the UE is estimated using at least in part the network node and the second position of the UE is estimated using at least in part the UE.

18. The method according to claim 12, wherein one or both of the first threshold and the second threshold are adjustable based on any one or more out of:
at least one characteristic of a system comprising the wireless communications network, wherein the at least one characteristic relates to a required precision of detection of a position of the UE in the wireless communications network;
at least one of the first integrity level of the first position and the second integrity level of the second position; and
a required position reliability of the UE.

19. (canceled)

20. (canceled)

21. A network node configured to determine reliability of positions of a User Equipment, UE, in a wireless communications network, the network node further being further configured to:
obtain a first position of the UE;
obtain a second position of the UE; and
determine whether or not the first position and the second position of the UE are reliable based on comparing of the first position of the UE, and the second position of the UE, by:
determining that the first position and the second position of the UE are reliable when the difference between the first position of the UE and the second position of the UE is below a first threshold; and
determining that the first position and the second position of the UE are not reliable when the difference between the first position of the UE and the second position of the UE is above a second threshold.

22. The network node according to claim 21, wherein one or more of:
the network node being further configured to any one or more out of:
obtain the first position of the UE by further obtaining an indication of a first integrity level of the first position; and
obtain the second position of the UE by further obtaining an indication of a second integrity level of the second position; and wherein
the network node is further configured to determine whether or not the first position and the second position of the UE are reliable by further basing it on the indications of the any one or more out of the first and second integrity levels; and
the network node is further configured to, when it is determined that the first position and the second position of the UE are not reliable when the difference between the first position of the UE and the second position of the UE is above the second threshold, send a warning that the first and second positions of the UE are not reliable, which warning is adapted to be sent to any one or more out of:
the UE;
an operator of the wireless communications network;
a human located in the vicinity of the UE;
a location server of the wireless communications network;
a controller of a facility, wherein the facility comprises the network node and the UE, and wherein the facility is located at least partially indoor; and
a controller of a drone system, wherein the drone system comprises the network node and the UE;
wherein the warning is adapted to comprise or be associated with any one or more out of: an instruction to modify operation of UE, the instruction comprising any one out of: an instruction to change a position of the UE and/or a vehicle or device associated with the UE, an instruction to halt operation of the UE and/or the vehicle or device, and an instruction to change the speed of the UE and/or the vehicle or device; and
the network node is further configured to send, to the UE, the first position of the UE.

23.-28. (canceled)

29. A User Equipment, UE, configured to determine reliability of positions of the UE in a wireless communications network, the UE being further configured to:
obtain a first position of the UE;
obtain a second position of the UE; and
determine whether or not the first position and the second position of the UE are reliable based on comparing of the first position of the UE, and the second position of the UE, by:
determining that the first position and the second position of the UE are reliable when the difference between the first position of the UE and the second position of the UE is below a first threshold; and
determining that the first position and the second position of the UE are not reliable when the difference between the first position of the UE and the second position of the UE is above a second threshold.

30. The UE according to claim 29, wherein one or more of:
the UE is further configured to any one or more out of:
obtain the first position of the UE by further obtaining an indication of a first integrity level of the first position;
obtain the second position of the UE by further obtaining an indication of a second integrity level of the second position; and wherein
the UE is further configured to determine whether or not the first position and the second position of the UE are reliable by further basing it on the indications of the first and second integrity levels;
the UE is further configured to:
when it is determined that the first position and the second position of the UE are not reliable when the difference between the first position of the UE and the second position of the UE is above the second threshold, send a warning that the first and second positions of the UE are not reliable, which warning is sent to any one or more out of:
the network node;
an operator of the wireless communications network;
a human located in the vicinity of the UE;
a location server of the wireless communications network;
a controller of a facility, wherein the facility comprises the network node and the UE, and wherein the facility is located at least partially indoor; and
a controller of a drone system, wherein the drone system comprises the network node and the UE; and
the UE is further configured to send, to the network node, the second position of the UE.

31.-36. (canceled)
